(19) United States
(12) Patent Application Publication
(10) Pub. No.: US 2021/0104341 A1
(43) Pub. Date: Apr. 8, 2021

(54) SINTERED MAGNET AND METHOD FOR PRODUCING SINTERED MAGNET

(71) Applicant: DAIDO STEEL CO., LTD., Nagoya-shi (JP)

(72) Inventors: Takanori Kawahara, Nagoya-shi (JP); Takayuki Tsuji, Nagoya-shi (JP); Yasuhiro Une, Nagoya-shi (JP)

(21) Appl. No.: 17/062,318

(22) Filed: Oct. 2, 2020

(30) Foreign Application Priority Data
Oct. 4, 2019 (JP) 2019-184005

(51) Int. Cl. H01F 1/057; B22F 3/10

(52) U.S. Cl. CPC H01F 1/0577; B22F 3/10; B22F 2301/10; B22F 2301/355; B22F 2301/155

(57) ABSTRACT

The present invention relates to a sintered magnet including a main phase including an R₂T₁₄B compound, in which the element R is a rare earth element, and the element T is Fe or includes Fe and Co with which a part of Fe is substituted, and a grain boundary phase which is present at a grain boundary triple junction and contains a rare earth element including a heavy rare earth element, Cu and the element T, in which a content of the rare earth element in the grain boundary phase as a whole is 55 mass % or more, and a Cu-rich region containing 8 mass % or more of Cu accounts for 9 vol % or more of the grain boundary phase.

### TECHNICAL FIELD

The present invention relates to an R-T-B-based sintered magnet and a method for producing the sintered magnet.

### BACKGROUND ART

An R-T-B-based sintered magnet (R is a rare earth element, and T is Fe or includes Fe and Co with which a part of Fe is substituted) is used as a kind of a rare earth magnet having high magnetic properties such as high coercivity. In the R-T-B-based sintered magnet, a grain boundary phase where the rare earth element is concentrated is formed at a grain boundary triple junction of a main phase including a crystal grain of an R-T-B-based compound. In this kind of sintered magnet, the magnetic properties of the sintered magnet can be particularly enhanced by decreasing amounts of rare earth element-containing impurities such as oxide, carbide and nitride, which are contained in the grain boundary phase. For example, when a press-less process method (PLP method) of completing the molding and sintering of a material in an inert atmosphere is used at the time of producing the sintered magnet, the content of impurities can be effectively decreased.

However, in the R-T-B-based sintered magnet, when the content of impurities is decreased, the grain boundary phase where the rare earth element is concentrated is readily eluted to the outside during exposure to a corrosive environment. When the grain boundary is eluted, since a main phase crystal grain is detached starting from such a portion where the grain boundary is eluted, corrosion of the sintered magnet develops. In other words, decreasing the content of impurities is likely to reduce a corrosion resistance of the sintered magnet. Accordingly, it is difficult to achieve both enhancing the magnetic properties by the decrease of impurities and ensuring the corrosion resistance.

For example, Patent Literature 1 discloses, as a rare earth magnet having excellent corrosion resistance, a rare earth magnet including a crystal grain group of an R-Fe-B-based alloy containing a rare earth element R, in which an alloy containing R, Cu, Co and Al is present in an R-rich phase included in a grain boundary triple junction of a crystal grain located in the surface part of the rare earth magnet, and the total content of Cu, Co and Al in the R-rich phase is 13 at % or more. Furthermore, Patent Literature 1 discloses that when the total content of Cu and Al in a crystal grain is 2 at % or less, not only the corrosion resistance but also satisfactory magnetic properties are imparted to the rare earth magnet.

Patent Literature 1: JP-A-2011-199180 (the term “JP-A” as used herein means an “unexamined published Japanese patent application”)

### SUMMARY OF INVENTION

In the R-T-B-based sintered magnet, as illustrated in Patent Literature 1, it may be possible to increase the corrosion resistance while ensuring high magnetic properties by controlling the composition of the grain boundary phase. However, in general, the composition of the grain boundary in the sintered magnet is not uniform and a plurality of regions differing in the composition are often mixed as the grain boundary phase. In such a case, the corrosion resistance of the sintered magnet may not be sufficiently increased only by specifying the composition of the grain boundary phase as a whole. Because, if a certain amount of a region which is susceptible to corrosion exists in the grain boundary phase together with a region which is resistant to corrosion, corrosion of the sintered magnet may develop starting from such a portion which is susceptible to corrosion. Thus, in the R-T-B-based sintered magnet, it is difficult to achieve both high magnetic properties and corrosion resistance.

The problem to be solved by the present invention is to provide an R-T-B-based sintered magnet having excellent magnetic properties and exhibiting high corrosion resistance, and a method for producing the sintered magnet.

Namely, the present invention relates to the following configurations (1) to (9).
(1) A sintered magnet including:

a main phase including an R₂T₁₄B compound, in which the element R is a rare earth element, and the element T is Fe or includes Fe and Co with which a part of Fe is substituted, and

a grain boundary phase which is present at a grain boundary triple junction and contains a rare earth element including at least one heavy rare earth element, Cu and the element T,

in which

a content of the rare earth element in the grain boundary phase as a whole is 55 mass % or more, and

a Cu-rich region containing 8 mass % or more of Cu accounts for 9 vol % or more of the grain boundary phase.
(2) The sintered magnet according to (1), in which a content of Cu in the grain boundary phase as a whole is 1.5 mass % or more.
(3) The sintered magnet according to (1) or (2), in which a total content of the at least one heavy rare earth element in the grain boundary phase as a whole is 1.0 mass % or more.
(4) The sintered magnet according to any one of (1) to (3), in which [Cu]/[T] is 0.05 or more, in which [Cu] represents the content of Cu in the grain boundary phase as a whole in terms of mass %, and [T] represents a content of the element T in the grain boundary phase as a whole in terms of mass %.
(5) The sintered magnet according to any one of (1) to (4), in which each of contents of O and C in the entire sintered magnet is 1,000 ppm by mass or less.
(6) The sintered magnet according to any one of (1) to (5), in which the sintered magnet includes at least one element selected from the group consisting of Dy, Tb and Ho as the heavy rare earth element, and a content of the heavy rare earth element in the entire sintered magnet is less than 10 mass %.
(7) A method for producing the sintered magnet according to any one of (1) to (6), the method including bringing a modifier containing the heavy rare earth element and Cu into contact with a base material obtained by sintering an R-T-B-based alloy powder, whereby the heavy rare earth element and Cu in the modifier are diffused into a grain boundary of the base material.
(8) The method according to (7), in which the modifier is an alloy containing Al in addition to the heavy rare earth element and Cu.
(9) The method according to (7) or (8), in which the base material is produced by molding and sintering the R-T-B-based alloy powder in an inert atmosphere.
The sintered magnet according to the present invention includes the Cu-rich region accounting for 9 vol % or more of the grain boundary phase and containing 8 mass % or more of Cu. The Cu-rich region is resistant to corrosion due to its high Cu concentration and contributes to the enhancement of the corrosion resistance of the sintered magnet. Such a Cu-rich region accounts for 9 vol % or more of the grain boundary phase as a whole, so that the corrosion resistance of the entire sintered magnet can be effectively increased. On the other hand, the grain boundary phase contains the heavy rare earth element and moreover, the content of the rare earth element in the grain boundary phase as a whole is 55 mass % or more, so that high magnetic properties such as high coercivity can be ensured.

Here, when the content of Cu in the grain boundary phase as a whole is 1.5 mass % or more, the content of Cu in the grain boundary phase as a whole is ensured, and the corrosion resistance of the sintered magnet can thereby be effectively increased.

In addition, when the content of the heavy rare earth element in the grain boundary phase as a whole is 1.0 mass % or more, due to the contribution of the heavy rare earth element, the magnetic properties of the sintered magnet, such as coercivity, can be particularly effectively enhanced.

When [Cu]/[T] is 0.05 or more, in which [Cu] represents the content of Cu in the grain boundary phase as a whole in terms of mass %, and [T] represents the content of the element T in the grain boundary phase as a whole in terms of mass %, the grain boundary phase contains an adequate amount of Cu relative to Fe or Co, so that corrosion of the sintered magnet starting from the grain boundary phase can be particularly effectively suppressed.

Furthermore, when each of the contents of 0 and C in the entire sintered magnet is 1,000 ppm by mass or less, an impurity concentration in the grain boundary phase is reduced and therefore, the magnetic properties of the sintered magnet, such as coercivity, can be maintained high. On the other hand, even if the impurity concentration in the grain boundary phase is low, since the Cu-rich region accounts for a predetermined volume, reduction in the corrosion resistance can be suppressed.

In the case where at least one element selected from the group consisting of Dy, Tb and Ho is contained as the heavy rare earth element and the content of the heavy rare earth element in the entire sintered magnet is less than 10 mass %, since at least one element selected from the group consisting of Dy, Tb and Ho is used as the heavy rare earth element and distributed at a high concentration in the grain boundary phase, a high effect on the enhancement of the magnetic properties can be obtained even if the content of the heavy rare earth element in the entire sintered magnet is reduced to less than 10 mass %.

In the method for producing the sintered magnet according to the present invention, the modifier containing the heavy rare earth element and Cu is brought into contact with the base material, whereby the heavy rare earth element and Cu in the modifier are diffused into a grain boundary of the base material. This step makes it possible to simply and easily produce the sintered magnet in which the rare earth elements including the heavy rare earth element and Cu are distributed at a high concentration in the grain boundary phase, and in turn, to achieve both high magnetic properties and corrosion resistance.

Here, in the case where the modifier is the alloy containing Al in addition to the heavy rare earth element and Cu, diffusion of the heavy rare earth element and Cu into the grain boundary of the base material can be efficiently progressed.

In the case where the base material is produced by molding and sintering the R-T-B-based alloy powder in the inert atmosphere, as typified by the PLP method, production of impurities such as oxide is suppressed in the grain boundary, so that a sintered magnet having high magnetic properties can be produced.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a schematic diagram illustrating a structure of the sintered magnet according to one embodiment of the present invention.

FIG. 2 is a diagram illustrating the results of corrosion resistance test using an Nd—Cu—Co model alloy.

FIGS. 3A and 3B illustrate the results of observation of the sintered magnet of Sample 1 by EPMA; FIG. 3A indicates a grain boundary phase based on a CP (Backscattered electron compositional) image, and FIG. 3B indicates a Cu-rich region based on the Cu concentration distribution.

FIGS. 4A and 4B illustrate the results of observation of the sintered magnet of Sample 3 by EPMA; FIG. 4A indicates a grain boundary phase based on a CP image, and FIG. 4B indicates a Cu-rich region based on the Cu concentration distribution.

### DESCRIPTION OF EMBODIMENTS

The sintered magnet according to one embodiment of the present invention and the production method thereof are described in detail below. In the present description, unless specified otherwise, the contents of the component elements are expressed in the unit of mass % or ppm by mass. In addition, the characteristic values are values as measured at room temperature.

### [Composition and Structure of R-T-B-Based Sintered Magnet]

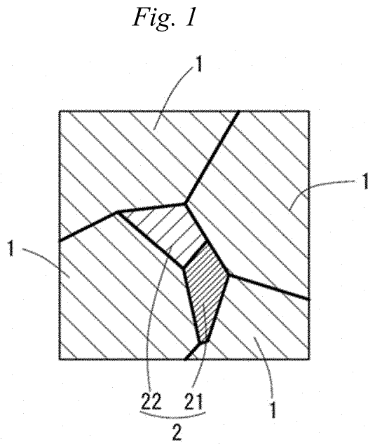

The sintered magnet according to one embodiment of the present invention is configured as an R-T-B-based sintered magnet and, as illustrated in FIG. 1, has a main phase (main phase crystal grain) 1 and a grain boundary phase 2. Most of the structure of the sintered magnet is occupied by the main phase crystal grains 1.

The main phase 1 is configured as a crystal grain of an R-T-B-based compound. Here, the element R is a rare earth element. The element T is Fe or includes Fe and Co with which a part of Fe is substituted, and the element T preferably includes Fe and Co with which a part of Fe is substituted. The type of the rare earth element R is not particularly limited, and examples thereof include Nd, Pr, Dy, Tb, La, and Ce. Among others, Nd and Pr can be favorably used as a rare earth element that is relatively inexpensive, nevertheless, gives high magnetic properties. The rare earth element R may be composed of only one type or may include a plurality of types. Typically, the main phase crystal grain 1 includes an R2T14B compound (e.g., Nd₂Fe₁₄B compound). The R-T-B-based compound constituting the main phase crystal grain 1 may further contain a metal element such as Al, Ga and Ni, in addition to respective elements of R, T, and B. The main phase 1 may be composed of only crystal grains having single component composition or may be composed of a mixture of crystal grains having two or more component compositions.

A grain boundary phase 2 is formed at a grain boundary triple junction between the main phase crystal grains 1. As described below, the grain boundary phase 2 includes a Cu-rich region 21 and a Cu-lean region 22, and the grain boundary phase 2, including both of the regions 21 and 22, includes a rare earth alloy containing the rare earth element, the element T, and Cu. In the grain boundary phase 2, the rare earth element is concentrated more than in the main phase 1, and the content of the rare earth element in the grain boundary phase 2 as a whole is 55 mass % or more. Part of the rare earth alloy constituting the sintered magnet including the grain boundary phase 2 may form a compound such as oxide, carbide or nitride, but it is preferred that each of the contents of O and C in the entire sintered magnet is reduced to 1,000 ppm or less.

As with the rare earth element constituting the main phase 1, although the rare earth element constituting the rare earth alloy of the grain boundary phase 2 is not particularly limited, it contains a heavy rare earth element as part thereof. Here, the heavy rare earth element indicates Gd to Lu and Y as commonly acknowledged. The heavy rare earth element preferably contains at least one element selected from the group consisting of Dy, Tb and Ho, which exhibit a high effect on the enhancement of the magnetic properties, and particularly preferably contains Tb. In the grain boundary phase 2, only one type of heavy rare earth element may be contained or a plurality of types of heavy rare earth elements may be contained. The content of the heavy rare earth element is preferably 1.0 mass % or more in terms of the content in the grain boundary phase 2 as a whole (the mass percentage of the heavy rare earth element in the grain boundary phase 2 as a whole). On the other hand, the content of the heavy rare earth element is preferably less than 10 mass % in terms of the content in the entire sintered magnet.

In the sintered magnet according to this embodiment, at least a part of the grain boundary phase 2 is the Cu-rich region 21. The Cu-rich region 21 includes the rare earth alloy, and the content of Cu in the rare earth alloy is 8 mass % or more. The Cu-rich region 21 may include a plurality of regions differing in the component composition as long as the content of Cu is 8 mass % or more at each position.

The grain boundary phase 2 may be composed of only the Cu-rich region 21 but may have a Cu-lean region 22 in coexistence with the Cu-rich region 21. It is rather rare to allow the grain boundary phase 2 to be formed of only a Cu-rich region 21, and in many cases, the grain boundary phase 2 includes both the Cu-rich region 21 and the Cu-lean region 22. As with the Cu-rich region 21, the Cu-lean region 22 also includes the rare earth alloy, but, unlike the Cu-rich region 21, the content of Cu in the Cu-lean region is less than 8 mass % (including an embodiment where Cu is not contained except for unavoidable impurities). The Cu-lean region 22 may also include a plurality of regions differing in the component composition as long as the content of Cu is less than 8 mass % at each position.

In the sintered magnet according to this embodiment, the Cu-rich region accounts for 9 vol % or more of the grain boundary phase as a whole. The percentage of the Cu-rich region 21 in the grain boundary phase 2 can be estimated using, for example, EPMA (electron probe microanalyzer). In a sample cross-section, the area of the grain boundary phase 2 is estimated based on a CP image, the area of the Cu-rich region 21 is estimated from the Cu concentration distribution image, and the ratio of these areas can be regarded as the volume ratio.

### [Properties of Sintered Magnet]

In the sintered magnet according to this embodiment, the grain boundary phase 2 is formed at the grain boundary triple junction between the main phase crystal grains 1, and the grain boundary phase 2 has the rare earth element content of 55 mass % or more as a whole and contains the heavy rare earth element. Consequently, the sintered magnet exhibits excellent magnetic properties including high coercivity.

From the viewpoint of effectively enhancing the magnetic properties of the sintered magnet, the content of the rare earth element in the grain boundary phase 2 is 55 mass % or more, preferably 57 mass % or more, more preferably 59 mass % or more. No upper limit is particularly placed on the content of the rare earth element in the grain boundary phase 2, but if the content of the rare earth element is too large, it is difficult to increase the Cu concentration in the grain boundary phase 2. Accordingly, the content of the rare earth element in the grain boundary phase 2 is preferably kept to 80 mass % or less.

In addition, from the viewpoint of more enhancing the magnetic properties of the sintered magnet, the content of the heavy rare earth element should be 1.0 mass % or more, furthermore, 1.2 mass % or more, in terms of the content in the grain boundary phase 2 as a whole. As the content of the heavy rare earth element in the grain boundary phase 2 is increased, the magnetic properties of the sintered magnet can be more enhanced, and therefore, no upper limit is particularly placed on the content, but from the viewpoint of, for example, preventing the material cost from rising due to a large amount of the heavy rare earth element contained, the content of the heavy rare earth element is preferably kept to less than 10 mass %, and more preferably kept to less than 2 mass %, in terms of the content in the entire sintered magnet. Particularly, in the case of using at least one element selected from the group consisting of Dy, Tb, and Ho as the heavy rare earth element, when such a heavy rare earth element is distributed at a high concentration in the grain boundary phase 2, a very high effect of enhancing the magnetic properties is exhibited and therefore, even containing a small amount, the magnetic properties of the sintered magnet can be enhanced. Incidentally, in the case where, as described later, introduction of the heavy rare earth element is performed through a step of modifying the grain boundary by the contact with a modifier, the heavy rare earth element concentration is likely to provide a distribution decreasing from the surface toward the inside in the entire sintered magnet.

If the grain boundary phase 2 contains impurities such as oxide, carbide, nitride etc. of the rare earth alloy, the magnetic properties of the sintered magnet, such as coercivity, are reduced. These impurities generally have a high melting point and therefore, do not form a liquid phase even after heating, as described later, in the sintering step, grain boundary modification step, aging step, etc. at the time of production of the sintered magnet and in turn, give rise to reduction in the magnetic properties of the sintered magnet even if they underwent the steps above. Accordingly, from the standpoint of enhancing the magnetic properties of the sintered magnet, the contents of these impurities are preferably reduced as much as possible. For example, when each of the contents of O and C in the entire sintered magnet is kept to 1,000 ppm by mass or less, high magnetic properties are easily obtained. The contents of impurities can be reduced, for example, as described later, by producing the sintered magnet by PLP method, etc. in an inert atmosphere.

The sintered magnet according to this embodiment can have, for example, a coercivity of 20 kOe or more by virtue of having the above-described grain boundary phase 2. The coercivity thereof is more preferably 23 kOe or more.

The sintered magnet according to this embodiment thus has high magnetic properties and at the same time, has high corrosion resistance. The high corrosion resistance comes from the fact that the Cu-rich region 21 having a Cu content of 8 mass % or more accounts for 9 vol % or more of the grain boundary phase 2.

As demonstrated in a test using a model alloy in Examples described later, when an R—Cu-T alloy is a Cu-rich alloy having a Cu content of 8 mass % or more, high corrosion resistance is exhibited. As described above, corrosion in the R-T-B-based sintered magnet is likely to occur triggered by elution of the grain boundary phase 2 and therefore, when an alloy containing a rare earth element R, Cu and the element T and occupying the grain boundary phase 2 is prepared from a composition resistant to corrosion, the corrosion of the entire sintered magnet can be effectively prevented. More specifically, when the rare earth alloy having the Cu content of 8 mass % or more is formed in the grain boundary phase 2, the corrosion resistance of the sintered magnet can be increased. The Cu-rich alloy has a low melting point of about 480° C. and readily forms a liquid phase when heated. Therefore, it is unlikely that the sinterability is reduced at the time of production of the sintered magnet or the magnetic properties are reduced after grain boundary modification or after aging. Consequently, the Cu-rich alloy can contribute to the enhancement of the corrosion resistance while keeping the magnetic properties high.

However, even when the Cu-rich alloy thus exhibiting high corrosion resistance is formed, if its amount is too small, the effect of enhancing the corrosion resistance cannot be sufficiently exerted. Then, the Cu-rich region 21 having the Cu content of 8 mass % or more is caused to account for 9 vol % or more of the grain boundary phase 2 as a whole, and the corrosion resistance of the entire sintered magnet can thereby be effectively enhanced due to the corrosion resistance-enhancing effect of the Cu-rich alloy. In particular, in the case where the content of the impurities such as oxide, carbide and nitride in the grain boundary phase 2 is kept small for the purpose of, for example, enhancing the magnetic properties of the sintered magnet, corrosion due to elution of the grain boundary phase 2 is likely to proceed, compared with the case of allowing a large amount of impurities to be contained, but in this case, when the Cu-rich region 21 is formed in the grain boundary phase 2, progress of corrosion can also be effectively suppressed. The percentage of the Cu-rich region 21 in the grain boundary phase 2 as a whole is preferably 10 vol % or more, and more preferably 15 vol % or more.

As long as the percentage of the Cu-rich region 21 in the grain boundary phase 2 is 9 vol % or more, specific component compositions of the Cu-rich region 21 and the Cu-lean region 22 are not particularly limited, but from the viewpoint of effectively increasing the corrosion resistance of the entire sintered magnet, the Cu content in the grain boundary phase 2 as a whole is preferably 1.5 mass % or more, more preferably 2.0 mass % or more, and further preferably 3.0 mass % or more. In addition, the ratio [Cu]/[T] is preferably 0.05 or more, more preferably 0.06 or more, and further preferably 0.08 or more, in which [Cu] represents the content of Cu in the grain boundary phase as a whole in terms of mass %, and [T] represents a content of the element T in the grain boundary phase as a whole in terms of mass %.

### [Production Method of Sintered Magnet]

Next, the production method of a sintered magnet according to one embodiment of the present invention, which can produce the sintered magnet according to the above-described embodiment, is described.

In the production method according to this embodiment, first, an R-T-B-based alloy powder is molded into a desired shape and sintered to form a base material. The specific production method of the base material is not particularly limited, but the base material is preferably produced by molding and sintering a powder material in an inert atmosphere. Examples of such a production method of the base material include a press-less process method (PLP method) capable of completing molding and sintering without involving a pressing step. In the PLP method, a raw material powder is filled into a mold formed of a carbon material, etc. and having a desired shape. Next, a magnetic field is applied to the entire mold to orient the particles of the raw material powder. After the completion of magnetic field application, the mold is heated at a predetermined sintering temperature in an atmosphere-controlled heating chamber for sintering the raw material powder to thereby obtain a sintered magnet. In a conventional general production method where a raw material powder is molded by performing press working in a magnetic field and then sintering is performed, it is difficult to block the contact between the raw material powder and the atmosphere during press working, whereas in the PLP method, each step from the production of a raw material powder to the filling into a mold and sintering can be performed under the controlled atmosphere, so that the content of impurities including air-derived components such as O, C and N can be remarkably reduced in the produced sintered magnet. After the sintering, an aging treatment is preferably applied at a temperature lower than the sintering temperature.

As for the R-T-B-based alloy powder as a raw material constituting the base material, an alloy powder having a composition desirable as the composition of the main phase 1 constituting a sintered magnet to be produced should be used in general. However, the heavy rare earth element is preferably introduced by the below-described grain boundary modification treatment and distributed concentratedly into the grain boundary phase 2, and therefore, the heavy rare earth does not need to be incorporated as a constituent material of the base material. In addition, if the content of the rare earth element in the alloy powder used for the production of the base material is too high, the content of the rare earth element in the grain boundary phase 2 excessively increases, and this makes it difficult for Cu to be contained in the grain boundary phase 2 at a high concentration. For this reason, the content of the rare earth element in the base material is preferably kept to 31 mass % or less, and more preferably kept to 30 mass % or less. The base material may be formed using only one type of a raw material powder or may be formed using two or more types of raw material powders.

When the base material is obtained as above, the base material is then subjected to the grain boundary modification treatment. In the grain boundary modification treatment, a modifier containing the heavy rare earth element and Cu is brought into contact with the surface of the base material. In this state, heating is appropriately performed in order for the heavy rare earth element and Cu to move into the inside of the base material and diffuse in the grain boundary. As a result, the heavy rare earth element and Cu can be distributed in the grain boundary phase 2.

With respect to the modifier, as long as it contains the heavy rare earth element and Cu to be distributed in the grain boundary of the produced sintered magnet, any alloy may be used, but an alloy containing Al in addition to the heavy rare earth element (RH) and Cu is preferably used. Because, not only the RH—Cu—Al alloy facilitates diffusion of Cu and the heavy rare earth element into the base material but also Al does not hinder the enhancement of magnetic properties or corrosion resistance of the sintered magnet even if it is diffused into the grain boundary phase 2 of the sintered magnet. The modifier may be brought into contact with the surface of the base material in a state that the modifier is a powder or the powder of the modifier is dispersed in a solvent or a binder.

The amount of the modifier to be brought into contact with the base material may be appropriately determined according to the amount of the heavy rare earth element or Cu to be distributed in the grain boundary of the produced sintered magnet, etc., but from the viewpoint of ensuring sufficient coercivity, the amount of the modifier used is preferably set such that the heavy rare earth element contained in the modifier accounts for 0.7 mass % or more relative to the base material. On the other hand, from the viewpoint of avoiding use of an excessive amount of the heavy rare earth element, the amount of the modifier used is preferably set such that the mass of the heavy rare earth element contained in the modifier is kept to less than 10 mass % relative to the mass of the base material. The heating temperature in the grain boundary modification treatment step should be set so that the heavy rare earth element and Cu can be sufficiently diffused, and, for example, in the case of using a Tb—Cu—Al alloy as the modifier, the heating temperature is preferably 850° C. or more.

### EXAMPLES

The present invention is described in detail below by referring to Examples. However, the present invention is not limited to the following Examples.

### [1] Corrosion Resistance of Nd—Cu—Co Model Alloy

First, as a basis for evaluating the relationship between the composition of the grain boundary phase and the corrosion resistance in the R-T-B-based sintered magnet, the relationship between the Cu content and the corrosion resistance was examined using an Nd—Cu—Co model alloy.

### (Test Method)

As Alloys 1 to 7, Nd—Cu—Co alloy samples containing Nd, Cu and Co in the contents shown in Table 1 were produced. At this time, an alloy button was produced by blending respective raw materials to afford a predetermined composition ratio with arc melting.

With respect to each alloy sample obtained, a cross-section was observed by EPMA, and the composition of the appeared phase was analyzed.

Furthermore, each alloy sample was evaluated for the corrosion resistance. In the evaluation, the alloy sample was immersed in ethylene glycol with water (ethylene glycol: water=1:1 in volume ratio) simulating an antifreeze, sealed, and left standing still in a constant temperature bath at 120° C. Every time a predetermined time elapsed, the alloy sample was taken out from ethylene glycol with water and after drying, the mass was measured. Then, the mass ratio relative to the initial state before immersion was calculated. The corrosion resistance of the alloy sample was rated as very low “C” when a reduction of the mass ratio was confirmed before 8 hours, the corrosion resistance of the alloy sample was rated as low “B” when a reduction of the mass ratio was confirmed after 8 hours and before 192 hours, the corrosion resistance of the alloy sample was rated as high “A” when a reduction of the mass ratio was confirmed after 192 hours and before 384 hours, and the corrosion resistance of the alloy sample was rated as very high “AA” when a reduction of the mass ratio was not observed even after 384 hours.

### (Test Results)

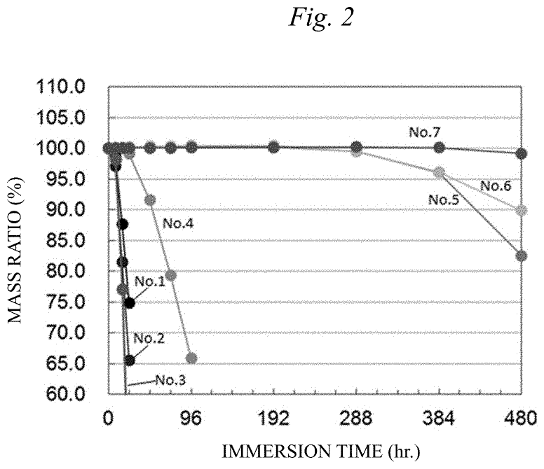

FIG. 2 illustrates the relationship between the immersion time and the mass ratio of the sample in the corrosion resistance evaluation test. The mass ratio is shown assuming the mass in the initial state is 100%. In addition, the appeared phase analysis results and the corrosion resistance evaluation results are shown in Table 1 together with the component composition of each alloy sample. In the appeared phase analysis, four types of phases, i.e., an Nd phase, a Co-rich phase, a Cu-rich phase and a eutectic phase, were observed. The Nd phase was substantially composed of Nd alone. The Co-rich phase was composed of an Nd—Cu—Co alloy having a large Co content and basically had a composition of Nd-4.4 Co-7.5 Cu. The Cu-rich phase was composed of an Nd—Cu—Co alloy having a large Cu content and basically had a composition of Nd-3.3 Co-24.2 Cu. The eutectic phase was composed of a eutectic crystal of Co-rich alloy and Cu-rich alloy. In Table 1, the appeared phase is denoted by “observed” when each phase was observed, and denoted by “not observed” when not observed. With respect to the samples in which the appeared phase is denoted by “-”, the EPMA analysis was not performed.

TABLE 1

| Alloy | Composition (mass %) | | | Appeared Phase | | | | Corrosion |
|---|---|---|---|---|---|---|---|---|
| No. | Cu | Co | Nd | Nd | Co-Rich | Cu-Rich | Eutectic | Resistance |
| 1 | 2.1 | 1.6 | bal. | observed | observed | not | not | C |
| | | | | | | observed | observed | |
| 2 | 2.0 | 3.1 | | — | — | — | — | C |
| 3 | 2.0 | 4.4 | | observed | observed | not | not | C |
| | | | | | | observed | observed | |
| 4 | 4.1 | 4.5 | | — | — | — | — | B |
| 5 | 8.0 | 4.4 | | observed | observed | not | observed | A |
| | | | | | | observed | | |
| 6 | 10.1 | 1.6 | | observed | not | not | observed | A |
| | | | | | observed | observed | | |
| 7 | 17.1 | 3.8 | | not | observed | observed | observed | AA |
| | | | | observed | | | | |

According to the results in Table 1, as the Cu content in the alloy is lager, the corrosion resistance is higher. In Alloys 1 to 4 where the Cu content is less than 8 mass %, sufficient corrosion resistance was not obtained, whereas in Alloys 5 to 7 where the Cu content is 8 mass % or more, high corrosion resistance was obtained. As seen also from FIG. 2, the behavior of the mass ratio relative to the immersion time greatly differs between Alloys 1 to 4 (No. 1 to No. 4) and Alloys 5 to 7 (No. 5 to No. 7), and in the former group, the mass ratio is significantly decreased in a short time, whereas in the latter group, the mass ratio gently decreases only after the elapse of a long time. In addition, according to Table 1, in Alloys 1 and 3, the Cu-rich phase and the eutectic phase are not observed, whereas in Alloys 5 to 7, the Cu-rich phase and/or the eutectic phase are observed.

These results demonstrate that when the Cu content is 8 mass % or more, the corrosion resistance of the Nd—Cu—Co alloy is increased and even after immersion in ethylene glycol with water for a long time, corrosion is less likely to occur. Furthermore, it is understood that the enhancement of the corrosion resistance is related to the formation of the Cu-rich phase and the eutectic phase. Incidentally, it is also confirmed that in the Nd—Cu—Co alloy, even when Co is substituted in part or in whole with Fe, almost the same behavior is exhibited.

### [2] Magnetic Properties and Corrosion Resistance of R-T-B-Based Sintered Magnet

Next, the relationship of the composition of the grain boundary phase with the coercivity and corrosion resistance in the R-T-B-based sintered magnet was examined

### (Test Method)

### (1) Production of Sample

Powder materials each including an alloy containing metal elements shown in Table 2 and B were prepared as base materials used in Samples 1 to 7, and sintered bodies were produced by PLP method. At the sintering, the powder was heated from room temperature up to the sintering temperature (from 985° C. to 1,050° C.), kept at the sintering temperature for 4 hours, and then cooled to room temperature. The treatment was performed under argon gas atmosphere between room temperature and 450° C. and thereafter, performed under vacuum atmosphere. Each of the sintered bodies obtained was processed into a plate-like specimen of 17 mm×17 mm×4.5 mm With respect to Samples 1 to 4, a grain boundary modification treatment was performed using the modifier whose type and amount used (mass ratio of Tb relative to the base material) are shown in Table 2. In the grain boundary modification treatment, both of two surfaces of 17 mm×17 mm of the specimen were coated with a paste obtained by adding silicone grease to the modifier powder. Then, a heat treatment at 885° C. for 15 hours was performed, and after that, an aging treatment was further performed. As the aging treatment, with respect to Samples 1 to 4, the sample was heated at 480° C. to 520° C. for 10 minutes. On the other hand, with respect to Samples 5 to 7, the sample was heated at a first aging temperature of 800° C. for 30 minutes, then cooled to a second aging treatment temperature of 520° C. to 560° C., and kept for 10 minutes. After the completion of heating, the samples all were rapidly cooled in a vacuum. The residue of the modifier remaining on the sample surface after the aging treatment was removed by grinding. With respect to Samples 5 to 7, the grain boundary modification treatment was not performed.

As shown in Table 2, in Samples 1 to 3, a TbCuAl alloy was used as the modifier, and all of them contain 75.3 mass % of Tb, 18.8 mass % of Cu, and 5.9 mass % of Al. In Sample 4, a TbNiAl alloy was used as the modifier, and the alloy contains 92 mass % of Tb, 4.3 mass % of Ni, and 3.7 mass % of Al. In Table 2, the contents of O and C of the base material produced by the PLP method, which were obtained by the actual measurement with the infrared absorption method, are shown together with the component composition of the powder material used.

TABLE 2

| Sample | Base Material Composition (mass %; O and C: ppm) | | | | | | | | | | | | | |
|---|---|---|---|---|---|---|---|---|---|---|---|---|---|---|
| No. | Nd | Pr | Dy | Tb | Co | B | Al | Cu | Ga | Zr | Fe | O | C | Modifier |
| 1 | 26.2 | 4.67 | 0.16 | 0.00 | 0.90 | 0.97 | 0.16 | 0.11 | 0.00 | 0.00 | bal. | 490 | 322 | TbCuAl 0.7 mass % |
| 2 | 25.0 | 4.45 | 0.21 | 0.00 | 2.93 | 1.06 | 0.21 | 0.21 | 0.20 | 0.00 | bal. | 441 | 361 | TbCuAl 1.0 mass % |
| 3 | 25.0 | 4.42 | 0.00 | 0.00 | 2.50 | 0.99 | 0.20 | 0.12 | 0.09 | 0.10 | bal. | 640 | 323 | TbCuAl 1.0 mass % |
| 4 | 26.9 | 4.70 | 0.00 | 0.00 | 0.90 | 0.98 | 0.16 | 0.12 | 0.00 | 0.00 | bal. | 652 | 383 | TbNiAl 1.0 mass % |
| 5 | 26.5 | 4.60 | 0.00 | 0.00 | 0.93 | 0.97 | 0.66 | 0.11 | 0.00 | 0.00 | bal. | 604 | 242 | none |
| 6 | 26.8 | 4.68 | 0.00 | 0.00 | 0.91 | 0.97 | 0.17 | 0.12 | 0.00 | 0.00 | bal. | 958 | 294 | none |
| 7 | 26.1 | 4.52 | 0.00 | 0.00 | 0.91 | 0.98 | 0.17 | 0.12 | 0.00 | 0.10 | bal. | 490 | 365 | none |

### (2) EPMA Analysis

For each of the samples obtained, EPMA analysis of a cross-section was performed. Then, with respect to the grain boundary phase formed at the grain boundary triple junction, the component composition of the grain boundary phase as a whole was evaluated. Furthermore, in all grain boundary phases, the percentage of the Cu-rich region was evaluated. In evaluating the percentage of the Cu-rich region, the total area of the grain boundary phases was estimated from a CP image and at the same time, assuming the Cu-rich region is a region where the Cu content reached 8 mass % or more, the area thereof was estimated based on a Cu concentration distribution image. Thereafter, the ratio of the area of the Cu-rich region relative to the total area of the grain boundary phases was calculated.

### (3) Measurement of Coercivity

Furthermore, each of the samples obtained above was measured for the coercivity. The coercivity was measured by obtaining a magnetization curve by means of a pulsed field magnetometer.

### (4) Evaluation of Corrosion Resistance

In addition, each of the samples obtained above was measured for the corrosion resistance. The corrosion resistance was evaluated in the same manner as in test [1] above. More specifically, the sample was immersed in ethylene glycol with water, sealed, and left standing still in a constant temperature bath at 120° C. During standing still, the mass ratio of the sample relative to the initial state before immersion was measured every time a predetermined time elapsed, and the time at which the mass ratio starts decreasing was recorded. Incidentally, the R-T-B-based sintered magnet is not corroded by ethylene glycol itself, but since an organic acid produced by the oxidation/decomposition of ethylene glycol in the ethylene glycol with water corrodes the sintered magnet, contribution of such an organic acid for corrosion is observed in this corrosion resistance test.

### (Test Results)

The composition of the grain boundary phase as a whole obtained by EPMA analysis is shown in Table 3. Furthermore, in Table 4, the composition of the grain boundary phase as a whole is summarized based on the values of Table 3, and the percentage of the Cu-rich region in the grain boundary phase, the coercivity measurement results, and the corrosion resistance evaluation results are also shown together. With respect to the composition of the grain boundary phase as a whole, the total rare earth amount (TRE) and the total heavy rare earth amount (TRH) are shown together with the total content of Fe and Co (i.e., the content of the element T). In addition, the content ratio [Cu]/[T] between Cu and the element T is shown using “Cu/T”.

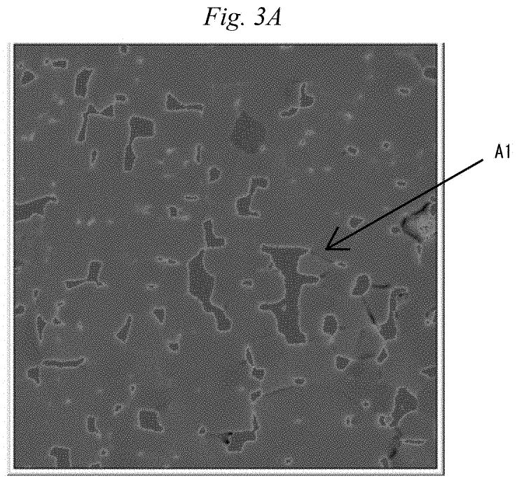

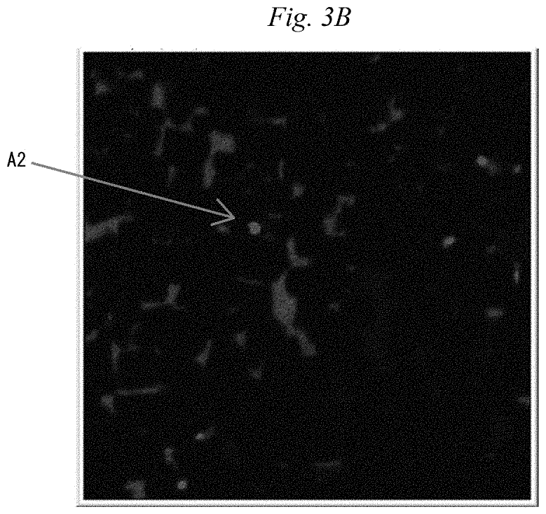

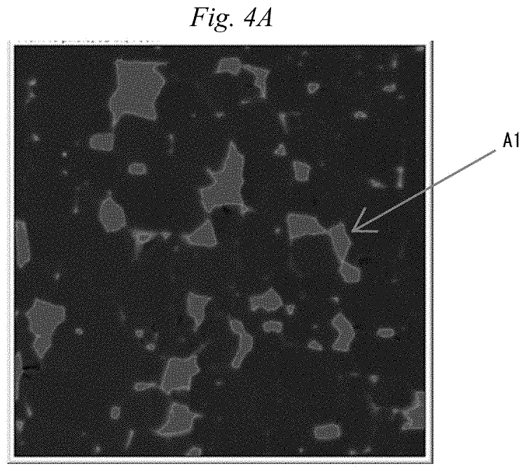

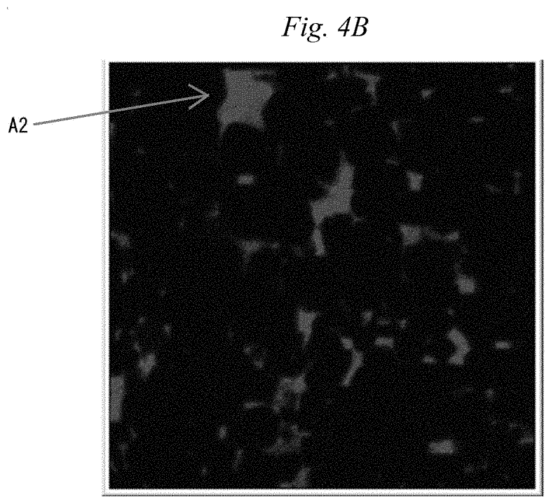

Furthermore, CP images (FIGS. 3A and 4A) and Cu concentration distribution images (FIGS. 3B and 4B) used for evaluating the percentage of the Cu-rich region in the grain boundary phase on Samples 1 and 3 as representatives are illustrated in FIGS. 3A, 3B, 4A and 4B, respectively. In each image, one side corresponds to 32 μm.

TABLE 3

| Sample | | Grain Boundary Composition (mass %) | | | | | | | | | |
|---|---|---|---|---|---|---|---|---|---|---|---|
| No. | Modifier | Nd | Pr | Dy | Tb | Co | Al | Cu | Ga | Zr | Fe |
| 1 | TbCuAl 0.7 mass % | 50.6 | 8.9 | 0.4 | 0.4 | 2.4 | 0.1 | 1.0 | 0.0 | 0.0 | 36.3 |
| 2 | TbCuAl 1.0 mass % | 48.0 | 8.5 | 0.4 | 0.8 | 5.2 | 0.1 | 3.3 | 0.0 | 0.0 | 33.7 |
| 3 | TbCuAl 1.0 mass % | 53.8 | 4.9 | 0.0 | 1.0 | 1.5 | 0.2 | 1.9 | 0.8 | 0.1 | 29.5 |
| 4 | TbNiAl 1.0 mass % | 64.6 | 13.7 | 0.0 | 1.7 | 2.7 | 0.2 | 0.3 | 0.0 | 0.0 | 12.3 |
| 5 | none | 42.2 | 9.7 | 0.0 | 0.0 | 2.4 | 0.8 | 0.5 | 0.0 | 0.0 | 40.5 |
| 6 | none | 60.2 | 13.6 | 0.0 | 0.0 | 3.9 | 0.2 | 0.8 | 0.0 | 0.0 | 15.0 |
| 7 | none | 54.2 | 11.9 | 0.0 | 0.0 | 4.3 | 0.2 | 1.0 | 0.0 | 0.0 | 22.4 |

TABLE 4

| | | | | | | Percentage of | | Corrosion |
|---|---|---|---|---|---|---|---|---|
| Sample | | TRE | TRH | T = Fe + Co | | Cu-Rich Phase | Coercivity | Resistance |
| No. | Modifier | (mass %) | (mass %) | (mass %) | Cu/T | (vol %) | (kOe) | (hr.) |
| 1 | TbCuAl | 60.3 | 0.8 | 38.7 | 0.03 | 0.8 | 25.2 | 120 |
| | 0.7 mass % | | | | | | | |
| 2 | TbCuAl | 57.7 | 1.2 | 38.9 | 0.08 | 9.1 | 23.0 | >3000 |
| | 1.0 mass % | | | | | | | |
| 3 | TbCuAl | 59.7 | 1.0 | 31.0 | 0.06 | 15.2 | 23.6 | >3000 |
| | 1.0 mass % | | | | | | | |
| 4 | TbNiAl | 80.0 | 1.7 | 15.0 | 0.02 | 0.2 | 25.3 | 30 |
| | 1.0 mass % | | | | | | | |
| 5 | none | 51.9 | 0.0 | 42.9 | 0.01 | 0.0 | 18.0 | 90 |
| 6 | none | 73.8 | 0.0 | 18.9 | 0.04 | 0.0 | 15.3 | 30 |
| 7 | none | 66.1 | 0.0 | 26.7 | 0.04 | 1.4 | 14.9 | 60 |

First, referring to the composition of the base material shown in Table 2, in all samples, both the contents of O and C are kept to 1,000 ppm or less in response to the fact that the base material was produced using PLP method.

Then, referring to the composition of the grain boundary phase of Table 3, in all samples, the concentration of the rare earth element including Nd is high, compared with the composition of the entire base material of Table 2, and it is confirmed that in the grain boundary phase, concentration of the rare earth element occurred. Furthermore, in Samples 1 to 4 where the grain boundary modification treatment was performed using a Tb-containing modifier, Tb is detected in the grain boundary phase. In addition, in Samples 1 to 3, when Sample 1 is compared with Samples 2 and 3, the content of Tb in the grain boundary phase is more increased in Samples 2 and 3 where the amount of Tb used as the modifier is increased, than in Sample 1. From these, it is confirmed that the heavy rare earth element was diffused into the grain boundary by performing the grain boundary modification treatment using the modifier containing the heavy rare earth element.

According to the results in Table 4, in all of Samples 5 to 7 where the grain boundary modification treatment using the modifier containing the heavy rare earth element was not performed, the coercivity was less than 20 kOe, whereas in all of Samples 1 to 4 where the grain boundary modification treatment was performed and a Tb-containing grain boundary phase was formed, the coercivity was 20 kOe or more. From these, it is confirmed that the coercivity of the sintered magnet can be enhanced by distributing the heavy rare earth element at a high concentration in the grain boundary phase.

Furthermore, according to Table 4, in Samples 5 to 7 where the grain boundary modification treatment was not performed and in Sample 4 where the Tb—Ni—Al alloy was used for the grain boundary modification treatment, the corrosion resistance evaluation showed that mass loss due to corrosion starts in a short time of 100 hours or less, whereas in Samples 1 to 3 where the grain boundary modification was performed using the Tb—Cu—Al alloy, the corrosion resistance evaluation showed that the time until mass loss due to corrosion starts exceeds 100 hours. Particularly, in Samples 2 and 3, mass loss was not observed even after 3,000 hours elapsed, and they have very high corrosion resistance.

Here, the attention is focused on the percentage of the Cu-rich region in the grain boundary phase. First, viewing images obtained by EPMA analysis of FIGS. 3A, 3B, 4A and 4B, a gray island region indicated by arrow Al in the CP images of FIGS. 3A and 4A corresponds to the grain boundary phase present at the grain boundary triple junction (in a color image, displayed in red). On the other hand, a gray region indicated by arrow A2 in the Cu concentration distribution images of FIGS. 3B and 4B corresponds to the Cu-rich region where the Cu content reached 8 mass % or more (in a color image, displayed in red). In both Sample 1 of FIGS. 3A, 3B and Sample 3 of FIGS. 4A, 4B, it is seen that the Cu-rich region is formed in FIGS. 3B and 4B and occupies part of the grain boundary phase observed in FIGS. 3A and 4A. However, in Sample 1 of FIGS. 3A and 3B, the number of Cu-rich regions is small and the area of each single region is narrow, whereas in Sample 3 of FIGS. 4A and 4B, the number of Cu-rich regions is increased and the area of each single region is also widened. In this way, in Sample 3, the percentage of the area occupied by the Cu-rich region in the grain boundary phase as a whole is apparently increased than in Sample 1.

Such a comparison in terms of the area occupied by the Cu-rich region is further clearly indicated in Table 4 by the results of quantitative estimation of, including other samples, the percentage of the Cu-rich region in the grain boundary phase as a whole, making it possible to examine the relationship with the corrosion resistance evaluation results. In Table 4, Samples 2 and 3 where high corrosion resistance was observed show that the percentage of the Cu-rich region in the grain boundary phase is remarkably larger, compared with other samples, and is 9 vol % or more. It can be said from this that when the percentage of the Cu-rich region containing 8 mass % or more of Cu is 9 vol % or more of the grain boundary phase as a whole, high corrosion resistance is obtained in the sintered magnet. The test [1] above using the model alloy confirms that when the Nd—Cu—Co alloy contains 8 mass % or more of Cu, high corrosion resistance is obtained, and it is considered that a Cu-rich region where the Cu content reached 8 mass % or more is formed also in the grain boundary phase scattered in the structure of the R-T-B-based sintered magnet, thereby contributing to the enhancement of the corrosion resistance of the sintered magnet. However, in order for such a Cu-rich region to effectively contribute to the enhancement of the corrosion resistance of the sintered magnet, the Cu-rich region needs to occupy a certain degree of large volume in the grain boundary phase, and the percentage of the Cu-rich region necessary for the enhancement of corrosion resistance is 9 vol % or more of the grain boundary phase as a whole.

It becomes apparent from the above that in the R-T-B-based sintered magnet, when 55 mass % or more of the rare earth element including the heavy rare earth element is contained in the grain boundary phase and at the same time, the Cu-rich region having the Cu content of 8 mass % or more accounts for 9 vol % or more of the grain boundary phase as a whole, both high magnetic properties and corrosion resistance can be achieved. Incidentally, in Samples 2 and 3, the Cu-rich region accounts for 9 vol % or more of the grain boundary phase as a whole and in addition, not only the Cu content in the grain boundary phase is 1.5% or more but also the Cu/T ratio is 0.05 or more. These are also likely to contribute to the enhancement of corrosion resistance of the grain boundary phase.

In Sample 4 where the grain boundary modification treatment was performed using the Tb—Ni—Al alloy, unlike the case where the grain boundary modification treatment was performed using the Tb—Cu—Al alloy, the corrosion resistance enhancing effect is not observed. This is considered to be attributable to the fact that Ni in the Tb—Ni—Al alloy can hardly be introduced into the grain boundary phase even after the grain boundary modification treatment.

The embodiments of the present invention have been described above in detail, but the present invention is not limited to the embodiments and Examples, and various changes and modifications can be made therein without departing from the gist of the present invention.

The present application is based on Japanese Patent Application No. 2019-184005 filed on Oct. 4, 2019, and the contents are incorporated herein by reference.

### DESCRIPTION OF REFERENCE NUMERALS AND SIGNS

1: Main phase (main phase crystal grain)

2: grain boundary phase

21: Cu-rich region

22: Cu-lean region.

What is claimed is:

1. A sintered magnet comprising:
a main phase comprising an R₂T₁₄B compound, in which the element R is a rare earth element, and the element T is Fe or comprises Fe and Co with which a part of Fe is substituted, and
a grain boundary phase which is present at a grain boundary triple junction and contains a rare earth element including at least one heavy rare earth element, Cu and the element T,
wherein
a content of the rare earth element in the grain boundary phase as a whole is 55 mass % or more, and
a Cu-rich region containing 8 mass % or more of Cu accounts for 9 vol % or more of the grain boundary phase.

2. The sintered magnet according to claim 1, wherein a content of Cu in the grain boundary phase as a whole is 1.5 mass % or more.

3. The sintered magnet according to claim 1, wherein a total content of the at least one heavy rare earth element in the grain boundary phase as a whole is 1.0 mass % or more.

4. The sintered magnet according to claim 2, wherein a total content of the at least one heavy rare earth element in the grain boundary phase as a whole is 1.0 mass % or more.

5. The sintered magnet according to claim 1, wherein [Cu]/[T] is 0.05 or more, in which [Cu] represents the content of Cu in the grain boundary phase as a whole in terms of mass %, and [T] represents a content of the element T in the grain boundary phase as a whole in terms of mass %.

6. The sintered magnet according to claim 2, wherein [Cu]/[T] is 0.05 or more, in which [Cu] represents the content of Cu in the grain boundary phase as a whole in terms of mass %, and [T] represents a content of the element T in the grain boundary phase as a whole in terms of mass %.

7. The sintered magnet according to claim 3, wherein [Cu]/[T] is 0.05 or more, in which [Cu] represents the content of Cu in the grain boundary phase as a whole in terms of mass %, and [T] represents a content of the element T in the grain boundary phase as a whole in terms of mass %.

8. The sintered magnet according to claim 4, wherein [Cu]/[T] is 0.05 or more, in which [Cu] represents the content of Cu in the grain boundary phase as a whole in terms of mass %, and [T] represents a content of the element T in the grain boundary phase as a whole in terms of mass %.

9. The sintered magnet according to claim 1, wherein each of contents of O and C in the entire sintered magnet is 1,000 ppm by mass or less.

10. The sintered magnet according to claim 2, wherein each of contents of O and C in the entire sintered magnet is 1,000 ppm by mass or less.

11. The sintered magnet according to claim 3, wherein each of contents of O and C in the entire sintered magnet is 1,000 ppm by mass or less.

12. The sintered magnet according to claim 4, wherein each of contents of O and C in the entire sintered magnet is 1,000 ppm by mass or less.

13. The sintered magnet according to claim 5, wherein each of contents of O and C in the entire sintered magnet is 1,000 ppm by mass or less.

14. The sintered magnet according to claim 6, wherein each of contents of O and C in the entire sintered magnet is 1,000 ppm by mass or less.

15. The sintered magnet according to claim 7, wherein each of contents of O and C in the entire sintered magnet is 1,000 ppm by mass or less.

16. The sintered magnet according to claim 8, wherein each of contents of O and C in the entire sintered magnet is 1,000 ppm by mass or less.

17. The sintered magnet according to claim 1, wherein the sintered magnet comprises at least one element selected from the group consisting of Dy, Tb and Ho as the heavy rare earth element, and a content of the heavy rare earth element in the entire sintered magnet is less than 10 mass %.

18. The sintered magnet according to claim 13, wherein the sintered magnet comprises at least one element selected from the group consisting of Dy, Tb and Ho as the heavy rare earth element, and a content of the heavy rare earth element in the entire sintered magnet is less than 10 mass %.

19. The sintered magnet according to claim 14, wherein the sintered magnet comprises at least one element selected from the group consisting of Dy, Tb and Ho as the heavy rare earth element, and a content of the heavy rare earth element in the entire sintered magnet is less than 10 mass %.

20. The sintered magnet according to claim 15, wherein the sintered magnet comprises at least one element selected from the group consisting of Dy, Tb and Ho as the heavy rare earth element, and a content of the heavy rare earth element in the entire sintered magnet is less than 10 mass %.
